(19) United States
(12) Patent Application Publication
(10) Pub. No.: US 2022/0325052 A1
(43) Pub. Date: Oct. 13, 2022

(54) SOLUTIONS FOR SOLVENT SWELLING AND SOLVENT BONDING

(71) Applicant: Illinois Tool Works Inc., Glenview, IL (US)

(72) Inventors: Saroj Yadav, Alpharetta, GA (US); Paul Blair, Jonesboro, GA (US)

(21) Appl. No.: 17/713,997

(22) Filed: Apr. 5, 2022

Related U.S. Application Data
(60) Provisional application No. 63/173,809, filed on Apr. 12, 2021.

(51) Int. Cl. C08J 5/12; C09J 9/00

(52) U.S. Cl. CPC C08J 5/122; C09J 9/00; C08J 2383/04; C08J 2327/06

(57) ABSTRACT

The present disclosure is generally directed to solvent mixtures for swelling and bonding polymeric substances for use in facilitating the connection of polymeric substances to other parts. A swelling solvent solution according to the present disclosure may comprise between 5% and 95% by volume n-Octane and between 5% and 95% by volume of either a heptane isomer (such as n-Heptane) or a nonane isomer (such as n-Nonane). The swelling solvent solution may be used to swell polymeric parts to enable the parts to be attached to other parts. A bonding solvent solution according to the present disclosure may comprise between 2% and 98% by volume of at least one of: acetone, MEK, heptane, octane, nonane, isohexane, and THF, and between 2% and 98% by volume cyclohexanone. The bonding solvent solution may be used to bond polymeric parts to other parts.

### CROSS-REFERENCE TO RELATED APPLICATIONS

This application claims benefit of priority from U.S. provisional patent application No. 63/173,809, filed Apr. 12, 2021, which is hereby incorporated by reference in its entirety herein.

### FIELD

This disclosure relates generally to solvent mixtures for swelling and bonding polymeric substances—such as silicone, polyurethane, and polyvinylchloride (“PVC”)—for use in facilitating the connection of polymeric parts to other parts.

### BACKGROUND

The most commonly used polymeric materials in medical devices are silicone, polyurethane and PVC. Silicone and polyurethane parts are thermosetting polymers. PVC is thermoplastic. The key difference between these two classes of polymers is that thermosetting polymers cannot be re-melted and re-shaped, whereas thermoplastic polymers can be re-melted and re-shaped. Thermoplastic and thermosetting polymers are characteristic for their ability to undergo solvent swelling.

One major application area for single-use medically approved PVC materials is in flexible containers. For example, flexible containers made from PVC are used for blood and blood components storage, urine collection, and ostomy products. Another major application area for single-use medically approved PVC compounds is tubing. For example, tubing made from PVC is used for blood taking and blood giving sets, catheters, heart-lung bypass sets, and hemodialysis sets.

PVC tubing has several characteristics that present challenges related to connecting it to rigid parts. These characteristics include its inability to expand or stretch without mechanical or chemical assistance, its tacky surface with a high coefficient of friction, and its rigidity. These properties make it difficult to slide a PVC tube onto a fitting. Forcing PVC tubing onto fittings can result in wasted time, damaged assemblies, or poor reliability of the connection. In some cases, the connection may not even be possible.

Swelling agents are one effective way to facilitate attachment of PVC parts to other PVC parts or to other hard plastic or metal parts. Swelling agents are solvents or solvent blends that are absorbed relatively quickly into the material. Upon absorption of the swelling solvent (or solvent blend), the polymer is expanded to a desired dimension. This expansion allows the PVC tube or part to easily accept the fitting or rigid part. Swelling agents also facilitate joining the parts by lubricating the PVC surface. Once the PVC part or tube is in place, the solvent evaporates and the PVC returns to its original size, thus creating a tight, strong connection.

Silicone and polyurethane tubing and parts are used in similar applications as PVC tubing and parts. Silicone and polyurethane may have even wider use than PVC due to several desirable characteristics. These include reliable mechanical properties (e.g., strength and toughness), material purity, chemical inertness, biological inactivity, and tolerance to high temperature and radiation (desirable for sterilization). Silicone and polyurethane are generally considered to be elastomeric polymers. Therefore, materials made from silicone and polyurethane are generally less rigid than comparable PVC materials.

Silicone and polyurethane materials also present similar challenges to PVC when connecting them to rigid parts. Silicone and polyurethane surfaces both have high coefficients of friction. This causes difficulties, for example, in attaching silicone and polyurethane tubing to fittings (e.g., sliding a tube over a barbed fitting or fitting whose outer diameter (“OD”) is larger than the inner diameter (“ID”) of the tube).

Similar to PVC, swelling agents are one effective way to facilitate attachment of silicone and polyurethane parts to each other or to other hard plastic or metal parts. For example, swelling agents facilitate fitting silicone or polyurethane tubing to a fitting by: (1) enlarging the ID and OD of the tube; (2) softening the tube so that it stretches easily; and (3) lubricating the surface of the tube. Without swelling agents, certain connections may be very difficult or even impossible. Forcing silicone or polyurethane parts together can result in wasted time, damaged assemblies, or poor reliability of the connection. In some cases, the connection may not even be possible.

Currently available swelling agents for plastic materials only swell the material for a short period of time. There exists a need for swelling agents that swell plastic materials for longer time periods to improve efficiency in attaching plastic materials.

Solvent bonding is another technique employed in attaching polymer tubing and parts together. This process is also known as solvent welding. Solvent bonding involves temporarily softening and dissolving the molecules on the polymers' surfaces. As the polymers are dissolved, these surface molecules mix together. A permanent seal is formed as the solvent evaporates.

Rotary press heat sealing and radio-frequency (“RF”) welding are other commonly used techniques for bonding polymeric materials. However, certain materials and shapes are not easily bonded with these techniques. Product fabrication of medical products, for example, commonly presents challenges with using rotary press heat sealing and RF welding.

Solvent bonding can be used to seal a variety of material combinations. Examples include, but are not limited to, synthetic rubbers (e.g., Hypalon) to polyurethane, PVC to PVC, PVC to polyurethane, along with other combinations of natural and synthetic rubbers. For example, commercially available “PVC cements” are solvent bonding solutions used in the plumbing and construction industries. These solutions are generally blends of cyclohexanone, acetone, methyl ethyl ketone (“MEK”), tetrahydrofuran (“THF), PVC resin, and silica. Dyes are also included in some PVC cements.

Solvent bonding is also commonly used in medical device fabrication. Medical containment bags are one example. Medical containment bags generally include an inlet for air intake or fluid transfer. Solvent bonding may be employed to securely attach polymer tubing to the inlet fitting on the bag's surface. More specifically, the polymer tubing is submerged in a suitable solvent (e.g., cyclohexanone, MEK, THF, or ethyl acetate) to dissolve the material on the tube's surface. The tube is then securely placed on the polymer fitting while the surface molecules on the inside of the tube are still dissolved. Residual solvent transferred with the tubing subsequently dissolves the fitting's surface molecules, allowing the dissolved tubing and fitting materials to mix together. Once the solvent completely evaporates, a permanent seal forms between both the fitting and the tube.

Solvent blends may also be used as a way to customize bonding solvent properties to meet particular process compatibility needs. For example, certain solvents that have desirable properties for solvent bonding (e.g., cyclohexanone) can damage other parts of the piece that is being fabricated if spilled. To adjust solvent aggressiveness, highly active solvents such as cyclohexanone, methyl isobutyl ketone, and methyl ethyl ketone are blended with less active solvents such as heptane isomers, octane isomers, and other light (C6-C9) aliphatic hydrocarbons (linear, branched and cyclic). To lengthen or shorten work time and speed of bond formation, slower evaporating solvents such as cyclohexanone may be blended with faster evaporating solvents like n-heptane, heptane isomers, THF, MEK, or acetone.

There exists a need for safer and more effective solvent and solvent mixtures for solvent bonding applications in the medical industry.

### SUMMARY

According to one aspect of the present disclosure, a swelling solvent solution comprises between 5% and 95% by volume n-Octane. The swelling solvent solution may further comprise between 5% and 95% by volume of a heptane isomer such as n-Heptane. The swelling solvent solution may further comprise between 5% and 95% by volume of a nonane isomer such as n-Nonane. The amount of the n-Octane, the heptane isomer, and the nonane isomer may be selected based on the desired swelling time for a particular application.

According to another aspect of the present disclosure, a bonding solvent solution may comprise between 2% and 98% by volume of one or more of the following: acetone, methyl ethyl ketone (MEK), heptane, octane, nonane, isohexane, and tetrahydrofuran (THF); and between 2% and 98% by volume cyclohexanone. The amount of acetone, MEK, heptane, octane, nonane, isohexane, tetrahydrofuran, and cyclohexanone, may be selected based on the intended application.

According to another aspect of the present disclosure, a method for swelling and attaching a polymeric part may comprise providing a polymeric part; placing the polymeric part in a swelling solvent solution comprising between 5% and 95% by volume n-Octane to swell the polymeric part; and attaching the polymeric part to a second part. This method may further comprise repeating the providing, placing, and attaching in order to swell and attach a plurality of polymeric parts.

According to another aspect of the present disclosure, a method for bonding a polymeric part may comprise providing a polymeric part; applying a bonding solvent solution to a surface of the polymeric part; and bonding the polymeric part to a second part. The bonding solvent solution may comprise between 2% and 98% by volume of one or more of the following: acetone, methyl ethyl ketone (MEK), heptane, octane, nonane, isohexane, and tetrahydrofuran (THF); and between 2% and 98% by volume cyclohexanone. The method may further comprise repeating the providing, placing, and attaching in order to bond and attach a plurality of polymeric parts.

It is to be understood that both the foregoing general description and the following detailed description describe various embodiments and are intended to provide an overview or framework for understanding the nature and character of the claimed subject matter. The accompanying drawings are included to provide a further understanding of the various embodiments, and are incorporated into and constitute a part of this specification. The drawings illustrate the various embodiments described herein, and together with the description serve to explain the principles and operations of the claimed subject matter.

### BRIEF DESCRIPTION OF THE DRAWINGS

The following is a description of the examples depicted in the accompanying drawings. The figures are not necessarily to scale, and certain features and certain views of the figures may be exaggerated in scale or in schematic for clarity or conciseness.

FIG. 1 illustrates an example method for solvent swelling in accordance with aspects of this disclosure; and

FIG. 2 illustrates an example method for solvent bonding in accordance with aspects of this disclosure.

The foregoing summary, as well as the following detailed description, will be better understood when read in conjunction with the figures. It should be understood that the claims are not limited to the arrangements and instrumentality shown in the figures. Furthermore, the appearance shown in the figures is one of many ornamental appearances that can be employed to achieve the stated functions of the apparatus.

### DETAILED DESCRIPTION

In the following detailed description, specific details may be set forth to provide a thorough understanding of the embodiments of the present disclosure. However, it will be clear to one skilled in the art when disclosed examples may be practiced without some or all of these specific details. For the sake of brevity, well-known features or processes may not be described in detail. In addition, like or identical reference numerals may be used to identify common or similar elements.

One or more specific embodiments of the present disclosure will be described below. In an effort to provide a concise description of these embodiments, all features with an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” “the,” and “said” are intended to mean that there are one or more of the elements. The terms “comprising,” “including,” and “having” are intended to be inclusive and mean that there may be additional elements other than the listed elements.

Parts and tubing made from thermoplastic and thermosetting polymers may be desirable for fabricating devices (e.g., medical devices). However, attaching rigid polymeric parts and tubing can be challenging or sometimes impossible. Solvent swelling solutions can address this problem, but those that are currently available suffer from limited swelling time.

A swelling solvent solution according to the present disclosure may comprise between 5% and 95% by volume n-Octane. For example, the swelling solvent solution could comprise 5%, 10%, 25%, 50%, 75%, or 95% by volume n-Octane, such as 70 to 90% by volume or approximately 80% by volume n-Octane. A part made of a polymer material (such as polymeric tubing) may be placed in the swelling solvent solution in order to swell the polymer material and make it easier to attach the part to another part.

Blending n-Octane and a heptane isomer (such as n-Heptane) may be advantageous in order to fine tune the properties of the swelling solvent solution. For example, increasing the percent composition by volume of the heptane isomer relative to n-Octane may decrease the time that the polymer material remains swollen after removal from the swelling solvent solution. In contrast, increasing the percent composition by volume of n-Octane relative to the heptane isomer may increase the time that the polymer material remains swollen. For certain applications, a longer swelling time may be desirable as a means to increase efficiency. For example, longer swelling times be useful for a fabrication process comprising multiple steps and parts. More specifically, multiple polymer parts or tubing can be swollen at the same time. Each part or tube that has been swollen can then be attached during the time all of the parts or tubing remain swollen. If the swelling time is too short, such a process may not be possible since the material will return to its original size before every part or tube can be attached.

According to certain embodiments of the present disclosure, the swelling solvent solution may further comprise between 0% and 95% or between 5% and 95% of a heptane isomer (such as n-Heptane). According to certain other embodiments of the present disclosure, the swelling solvent solution may further comprise between 0% and 95% or between 5% and 95% of a nonane isomer (such as n-Nonane). For example, the swelling solvent solution may further comprise 5%, 10%, 25%, 50%, 75%, or 95% by volume of a heptane isomer or a nonane isomer (or both). Blending n-Octane, a heptane isomer, and a nonane isomer may be advantageous in order to fine tune the properties of the swelling solvent. For example, increasing the percent composition by volume of the nonane isomer relative to the other solvents may increase the time that the polymer material remains swollen. In contrast, increasing the percent composition by volume of n-Octane and the heptane isomer relative to the nonane isomer may decrease the time that the polymer material remains swollen. As stated above, the desired swelling time may change depending on the intended application. According to certain embodiments of the present disclosure, the swelling solvent solution may further comprise between 0% and 95% or between 5% and 95% other similar hydrocarbons, including a hexane isomer (such as n-Hexane) and a pentane isomer (such as n-Pentane). For example, the swelling solvent solution may further comprise 5%, 10%, 25%, 50%, 75%, or 95% by volume of these other similar hydrocarbons. By tuning the particular blend of solvents, it is possible to tune the swelling properties to a particular application. The swelling solvent solution may further comprise additional diluents or inactive ingredients (such as other hydrocarbons) to change the strength of the solution.

It may be desirable to have a highly pure swelling solvent blend. For example, all components of the presently disclosed swelling solvent solution may be purified prior to being added to the swelling solvent solution. Each solvent may be purified using suitable methods, such as extraction, distillation, and azeotropic distillation. The swelling solvent solution may be further modified according to the present disclosure.

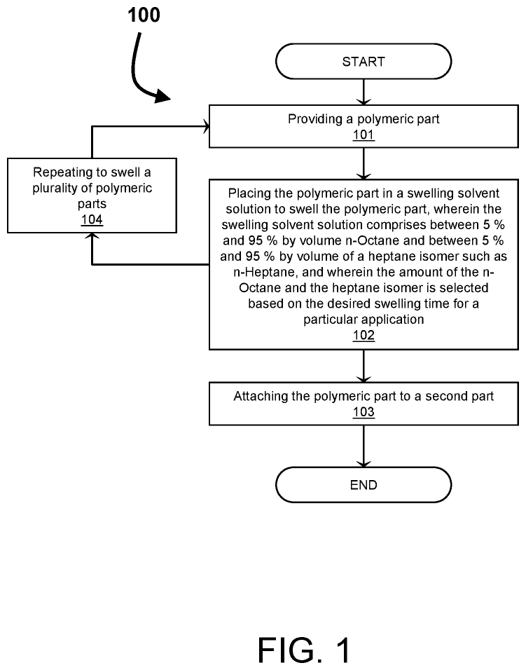

FIG. 1 illustrates an example method 100 for swelling a polymeric part. This example method involves providing a polymeric part 101, then placing the polymeric part in a swelling solvent solution to swell the polymeric part 102. The swelling solvent solution comprises between 5% and 95% by volume n-Octane and between 5% and 95% by volume of a heptane isomer such as n-Heptane. The amount of the n-Octane and the heptane isomer is selected based on the desired swelling time for a particular application. The method may then involve attaching the polymeric part to another part 103. The polymeric part may be attached to another polymeric part or a non-polymeric (such as a glass or metal) part. The method may be repeated to swell a plurality of parts 104. Further swelling of polymeric parts may take place either before or after attaching the polymeric part (or plurality of polymeric parts) 103. That is, one may swell a plurality of polymeric parts before assembling the polymeric parts, or swell and assemble the polymeric parts one after the other. It may be possible, and advantageous, to swell a plurality of polymeric parts and assemble the plurality of polymeric parts while they are each still swollen.

A bonding solvent solution according to the present disclosure may comprise between 2% and 98% by volume of one or more of the following: acetone, MEK, heptane, octane, nonane, isohexane, and THF; and between 2% and 98% by volume cyclohexanone. Optionally, the bonding solvent solution may comprise 15% to 25% or approximately 20% by volume cyclohexanone. Optionally, the bonding solvent solution may further comprise 75% to 85% or approximately 80% by volume heptane. According to certain embodiments, the bonding solvent solution may further comprise 2% to 98% by volume methyl isobutyl ketone (MIBK).

The composition by volume of each solvent in the bonding solvent solution according to the present disclosure may be adjusted within the ranges disclosed above. The desired blend may change depending on the intended application. For example, the solvent compositions may be selected in order to achieve a particular evaporation rate. The evaporation rate can impact both the speed and the effectiveness of the bonding process. The solvent compositions may also be selected to optimize for the solubility of a polymer (or multiple polymers) that is (or are) being bonded. Since solvent bonding works by dissolving the surface molecules of the polymer parts or tubes that are being bonded, the solubility of those polymers in the solvent blend has a significant impact on the bonding process. Therefore, there may be an optimum solubility for both the type of material being bonded and the thickness of the material being bonded.

Solvent bonding solutions may also need to be adjusted to optimize for process compatibility issues. For example, the composition of certain solvents (e.g., cyclohexanone) may need to be minimized due to instability of other components of the device being fabricated in the presence of those certain solvents. The bonding solvent solution may be further modified according to the present disclosure. For example, the bonding solvent solution may further comprise additional diluents or inactive ingredients (such as other hydrocarbons) to change the strength of the solution.

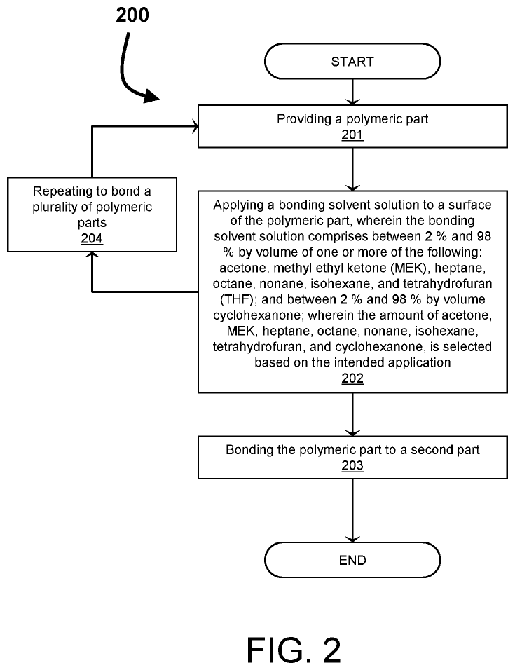

FIG. 2 illustrates an example method 200 for bonding a polymeric part. This example method involves providing a polymeric part 201, then applying a bonding solvent solution to a surface of the polymeric part 202. The bonding solvent solution comprises between 2% and 98% by volume of one or more of the following: acetone, MEK, heptane, octane, nonane, isohexane, and THF; and between 2% and 98% by volume cyclohexanone. The amount of acetone, MEK, heptane, octane, nonane, isohexane, tetrahydrofuran, and cyclohexanone, is selected based on the intended application. The method may then involve bonding the polymeric part to another part 203. The polymeric part may be bonded to another polymeric part or, where feasible, a non-polymeric (such as a glass or metal) part. The method may be repeated to bond a plurality of parts 204. Further bonding of polymeric parts may take place either before or after attaching the polymeric part (or plurality of polymeric parts) 203. That is, one may apply the bonding solvent solution to a plurality of polymeric parts before assembling the polymeric parts, or bond and assemble the polymeric parts one after the other. It may be possible, and advantageous, to apply the bonding solvent solution to a plurality of polymeric parts and to attach the plurality of polymeric parts before the parts have set into place and permanently bonded (i.e., while the parts are still “tacky”).

### Example 1: Swelling Solvent

In an example according to certain embodiments of the present disclosure, a swelling solvent solution may be used to attach an infusion line for surgeries. For retinal and vitreous surgeries, it may be necessary to infuse a patient's eye with saline. A metal port (cannula) is inserted in the sclera of the patient's eye. The end of the metal port or fitting opposite of the sharp insertion cannula may be inserted into the end of a silicone tube. The silicone tube is used to deliver the saline. A swelling solvent (n-octane) according to the present disclosure may be used to enlarge one end of the silicone tube so the fitting can be inserted.

In an effort to accelerate production of the cannula/silicon tube assembly a faster swelling and faster evaporating solvent was offered, n-heptane. However, the faster solvent actually slowed production. In the assembly process the operator dipped many silicone tube ends into the swelling solvent at once and inserted the metal fitting into each. Because the solvent evaporated quickly, some tubes had shrunk to their original diameter and required a second dipping into the swelling solvent. Consequently, an operator could not dip and swell as many tubes and could not complete as many assemblies at one time. Paradoxically, a slower-evaporating solvent allowed the operator to dip, swell and assemble more cannula/tube assemblies at one time.

As a result, when the process requires one assembly (or a limited number of assemblies), a faster-evaporating solvent according to the present disclosure has been found to improve productivity because the tube swells more quickly and returns to its original dimensions as part of the assembly more quickly. However, when a large number of assemblies are made at one time, a longer working time provided by a slower-evaporating solvent according to the present disclosure is beneficial because it reduces the frequency of the dipping and swelling step (i.e., it may be possible to complete the whole assembly with a single dipping/swelling step for each tube). In this example, a solution of 80% n-octane, 20% n-heptane provides a more efficient assembly by allowing for a longer open working time versus solutions that are 100% n-heptane or 80% n-heptane, 20% octane.

### Example 2: Bonding Solvent

In an example according to certain embodiments of the present disclosure, a bonding solvent solution may be used to attach tubes for a urinary drainage bag. The urinary drainage bag collects urine from a patient fitted with a Foley (urinary) catheter and stores it for later disposal. The catheter may connect to a urinary drainage bag via a flexible PVC tube. The flexible PVC tube may connect to entry and exit ports that are also made of PVC. Indeed, the urinary drainage bag, port fixtures (in and out), and tubes may each be made of PVC. A bonding solvent solution according to the present disclosure may be used to permanently fuse the flexible PVC tube to a more rigid PVC entry port on the urinary drainage bag. The urinary drainage bag also has a semi-rigid PVC exit or drainage port which is fused to a PVC tube using a bonding solvent solution. In alternative embodiments, a bonding swelling solution may be used to help facilitate a removable connection (i.e., so a flexible PVC tube may be attached to a rigid or semi-rigid PVC entry port but can later be removed).

In this example, when full strength (i.e., 100%) cyclohexanone bonding solvent spills onto both a PVC fitting and a PVC urinary drainage bag, the full strength cyclohexanone attacks the PVC bag to cause spotty blemishes, embrittlement, and structural weakness. Diluting the cyclohexanone to, for example, 70% cyclohexanone and 30% n-octane (with weaker solvent (n-octane)) prevents damage to the thin PVC of the bag when the solvent comes into contact with the bag without reducing the bonding effect of the cyclohexanone between the PVC fitting and tube.

While the present disclosure has been described with reference to certain implementations, it will be understood by those skilled in the art that various changes may be made and equivalents may be substituted without departing from the scope of the present method or system. In addition, many modifications may be made to adapt a particular situation or material to the teachings of the present disclosure without departing from its scope. For example, systems, blocks, or other components of disclosed examples may be combined, divided, re-arranged, or otherwise modified. Therefore, the present disclosure is not limited to the particular implementations disclosed. Instead, the present disclosure will include all implementations falling within the scope of the appended claims, both literally and under the doctrine of equivalents.

What is claimed is:

1. A swelling solvent solution comprising:
between 5% and 95% by volume n-Octane,
between 5% and 95% by volume of a heptane isomer such as n-Heptane, and
wherein the amount of the n-Octane and the heptane isomer is selected based on the desired swelling time for a particular application.

2. The swelling solvent solution of claim 1, comprising between 70% and 90% by volume n-Octane.

3. The swelling solvent solution of claim 1, comprising between 75% and 85% by volume n-Octane.

4. The swelling solvent solution of claim 1, further comprising between 5% and 95% by volume of a nonane isomer such as n-Nonane.

5. A swelling solvent solution comprising:
between 5% and 95% by volume n-Octane,
between 5% and 95% by volume of a nonane isomer such as n-Nonane, and
wherein the amount of n-Octane and the nonane isomer is selected based on the desired swelling time for a particular application.

6. The swelling solvent solution of claim 5, comprising between 70% and 90% by volume n-Octane.

7. The swelling solvent solution of claim 5, comprising between 75% and 85% by volume n-Octane.

8. A bonding solvent solution comprising:
between 2% and 98% by volume of one or more of the following: acetone, methyl ethyl ketone (MEK), heptane, octane, nonane, isohexane, and tetrahydrofuran (THF); and
between 2% and 98% by volume cyclohexanone,
wherein the amount of acetone, MEK, heptane, octane, nonane, isohexane, tetrahydrofuran, and cyclohexanone, is selected based on the intended application.

9. The bonding solvent solution of claim 8, comprising between 15 and 25% by volume cyclohexanone.

10. The bonding solvent solution of claim 8, comprising between 75 and 85% by volume heptane.

11. A method for swelling and attaching a polymeric part, comprising:
providing a polymeric part;
placing the polymeric part in the swelling solvent solution of claim 1 to swell the polymeric part; and
attaching the polymeric part to a second part.

12. The method of claim 11, wherein the second part is a second polymeric part.

13. The method of claim 11, wherein the second part is a non-polymeric part.

14. The method of claim 11, further comprising repeating the providing, placing, and
attaching in order to swell and attach a plurality of polymeric parts.

15. A method for swelling and attaching a polymeric part, comprising:
providing a polymeric part;
placing the polymeric part in the swelling solvent solution of claim 5 to swell the polymeric part; and
attaching the polymeric part to a second part.

16. The method of claim 15, wherein the second part is a second polymeric part.

17. The method of claim 15, wherein the second part is a non-polymeric part.

18. The method of claim 15, further comprising repeating the providing, placing, and
attaching in order to swell and attach a plurality of polymeric parts.

19. A method for bonding a polymeric part, comprising:
providing a polymeric part;
applying the bonding solvent solution of claim 8 to a surface of the polymeric part; and
bonding the polymeric part to a second part.

20. The method of claim 19, wherein the second part is a second polymeric part.

21. The method of claim 19, further comprising repeating the providing, placing, and
attaching in order to bond and attach a plurality of polymeric parts.
